(19) United States
(12) Patent Application Publication
(10) Pub. No.: US 2026/0350003 A1
(43) Pub. Date: Nov. 5, 2026

(54) DATA RETRIEVAL METHOD, APPARATUS AND SYSTEM BASED ON CLOUD COMPUTING

(71) Applicant: CHINA UNIONPAY CO., LTD., Shanghai (CN)

(72) Inventors: Tie LIU, Shanghai (CN); Jianbin GAO, Shanghai (CN); Zhirong SHEN, Shanghai (CN); Shuzhen WANG, Shanghai (CN); Chaobo LIN, Shanghai (CN)

(73) Assignee: CHINA UNIONPAY CO., LTD., Shanghai (CN)

(21) Appl. No.: 19/105,786

(22) PCT Filed: Dec. 1, 2022
(86) PCT No.: PCT/CN2022/135924

§ 371 Date: Feb. 21, 2025

(30) Foreign Application Priority Data
Aug. 23, 2022 (CN) 202211013674.6

(51) Int. Cl. G06F 16/2453; G06F 16/215; G06F 16/2455

(52) U.S. Cl. CPC G06F 16/24539; G06F 16/215; G06F 16/24552

(57) ABSTRACT

Disclosed in the present invention are a data retrieval method, apparatus and system based on cloud computing. The method comprises: acquiring a retrieval request, wherein the retrieval request comprises a first request field; according to the first request field, generating a second request field which meets a retrieval condition, wherein the first request field is different from the second request field, and the retrieval condition is generated on the basis of fields of data in a cloud database, and represents fields of data in the cloud database which allows indexing; and according to the second request field, retrieving the data from the cloud database, so as to obtain a first retrieval result. Since a second request field meets a retrieval condition, by means of retrieving data from a cloud database according to the second request field, the accuracy of the retrieved data can be ensured.

### CROSS-REFERENCES TO RELATED APPLICATIONS

The present disclosure is a National Stage of International Application No. PCT/CN2022/135924, filed on Dec. 1, 2022, which claims priority to Chinese patent application No. 202211013674.6, filed with China National Intellectual Property Administration on Aug. 23, 2022, the entire contents of which are incorporated herein by reference.

### TECHNICAL FIELD

The present disclosure relates to the field of data processing technology, and in particular relates to a data retrieval method, apparatus and system based on cloud computing.

### BACKGROUND

With the proliferation of information resources on the Internet and the rich variety of resources, more and more data need to be stored. After the concept of cloud computing, the data stored offline is gradually transferred to online storage. That is, the data is stored into the cloud database.

In order to prevent users from data silos when retrieving data, it is necessary to carry out data retrieval from each cloud database, and then realize data integration. Currently, the method of retrieving data from each cloud database is generally to send the retrieval request directly to retrieval engines. The retrieval engines interface with different cloud databases, and the retrieval engines are loaded with a unified retrieval service. When a user performs data retrieval, the unified retrieval service is invoked in the retrieval engines to retrieve data results from the cloud databases, and then the data results are integrated.

However, because enterprises manage data differently, the data formats of the cloud databases differ, and the retrieval conditions used to retrieve data also differ. If the data retrieval methods of cloud data sources are unified, the retrieval conditions used to retrieve data are the same, which can lead to errors when retrieving data. Moreover, loading the unified retrieval service has the problem of business logic development, i.e., the difficulty of business logic development and the high maintenance cost.

### SUMMARY

Embodiments of the present disclosure provide a data retrieval method, apparatus, and system based on cloud computing for adaptively retrieving data results from various cloud databases, improving the accuracy of the retrieved data, and avoiding the redevelopment of business logic, and reducing the difficulty of business logic development and maintenance costs.

In a first aspect, embodiments of the present disclosure provide a data retrieval method based on cloud computing, including: acquiring a retrieval request; where the retrieval request includes a first request field; generating a second request field that satisfies a retrieval condition based on the first request field; where the first request field is different from the second request field, and the retrieval condition is generated based on a field of data in a cloud database and indicates a field in the cloud database that is allowed to index data; and retrieving data from the cloud database based on the second request field to obtain a first retrieval result.

In the above technical solution, the data retrieval method based on cloud computing is performed by a data retrieval system including a scheduling service and a plurality of retrieval engines. The plurality of retrieval engines are provided with different retrieval conditions; and for any retrieval engine, the retrieval condition of the retrieval engine is generated based on a field in the cloud database interfaced with the retrieval engine, and indicates a field in the cloud database that is allowed to index data. The scheduling service is configured for acquiring a retrieval request sent by a user, and after obtaining the retrieval request, sending the retrieval request to each retrieval engine to retrieve data from the corresponding cloud database by each retrieval engine.

For any retrieval engine, the retrieval engine is preset with a retrieval condition. The retrieval engine generates a second request field based on the first request field in accordance with the corresponding retrieval condition, and the second request field satisfies the retrieval condition, thereby ensuring the accuracy of the retrieved data when retrieving the data from the cloud database based on the second request field. Additionally, there is no need to set up retrieval services in each retrieval engine, avoiding the redevelopment of business logic and reducing the difficulty of business logic development and maintenance costs.

Optionally, the data retrieval method further includes: after obtaining the first retrieval result, querying homogeneous data in the first retrieval result based on a cloud-native traffic transfer record; and after de-duplicating the homogeneous data in the first retrieval result, caching the de-duplicated first retrieval result to a primary cache space to obtain primary cache data; where the primary cache space includes a first conditional sequence list, a mapping relationship between the first request field and a primary index is recorded in the first conditional sequence list, and the primary index is used to index the primary cache data.

In the above technical solution, by de-duplicating homogeneous data, the same data in the retrieval results is avoided, and the accuracy of data retrieval is improved.

Optionally, the caching the de-duplicated first retrieval result to the primary cache space to obtain the primary cache data includes: calculating a capacity for caching the primary cache data; sorting and grouping fields in the first request field; sorting the de-duplicated first retrieval result based on the sorting and grouping of the fields; and caching the sorted first retrieval result to the primary cache space based on the capacity for caching the primary cache data.

Optionally, the calculating the capacity for caching the primary cache data includes: querying a capacity of the primary cache space and a capacity of the first retrieval result; and calculating the capacity for caching the primary cache data based on the capacity of the primary cache space and the capacity of the first retrieval result; where the capacity for caching the primary cache data is directly proportional to the capacity of the primary cache space, and the capacity for caching the primary cache data is inversely proportional to the capacity of the first retrieval result.

In the above technical solution, the capacity for caching the primary cache data is adjusted in real time and adaptively to avoid the waste of computer resources and improve the data retrieval efficiency.

Optionally, the data retrieval method further includes: after obtaining the primary cache data, retrieving data from the primary cache data according to the first request field to obtain a second retrieval result; caching the second retrieval result to a secondary cache space to obtain secondary cache data; where the secondary cache space includes a second conditional sequence list, a mapping relationship between the first request field and a secondary index is recorded in the second conditional sequence list, and the secondary index is used to index the secondary cache data; and feeding back the secondary cache data.

Optionally, the data retrieval method further includes: receiving an elimination instruction for primary cache data; where the elimination instruction is sent after the primary cache data has been modified; deleting from the secondary cache space the secondary cache data corresponding to the elimination instruction; and deleting from the primary cache space the primary cache data that has not been hit in a preset period.

In the above technical solution, the secondary cache data is adjusted in real time to ensure the consistency of the primary cache data and the secondary cache data. The waste of computer resources is avoided by deleting the primary cache data that has not been hit in the preset period from the primary cache space.

In a second aspect, embodiments of the present disclosure provide a data retrieval apparatus based on cloud computing, including: an acquisition module, configured for acquiring a retrieval request; where the retrieval request includes a first request field; and a processing module, configured for generating a second request field that satisfies a retrieval condition based on the first request field, and retrieving data from a cloud database based on the second request field to obtain a first retrieval result; where the first request field is different from the second request field, and the retrieval condition is generated based on a field of data in the cloud database and indicates a field in the cloud database that is allowed to index data.

In a third aspect, embodiments of the present disclosure provide a data retrieval system based on cloud computing, including: a scheduling service and a plurality of retrieval engines; where the plurality of retrieval engines are provided with different retrieval conditions; and for any retrieval engine, the retrieval condition of the retrieval engine is generated based on a field of data in a cloud database interfaced with the retrieval engine, and indicates a field in the cloud database that is allowed to index data; the scheduling service is configured for acquiring a retrieval request and sending the retrieval request to the retrieval engine; where the retrieval request includes a first request field; for any retrieval engine, the retrieval engine is configured for generating a second request field that satisfies a retrieval condition of the retrieval engine based on the first request field; where the first request field is different from the second request field; and the retrieval engine retrieves data from the cloud database based on the second request field to obtain a first retrieval result.

In a fourth aspect, embodiments of the present disclosure further provide a computer device including: a memory, configured for storing program instructions; a processor, configured for invoking the program instructions stored in the memory to execute the above data retrieval method based on cloud computing in accordance with the obtained program.

In a fifth aspect, embodiments of the present disclosure further provide a computer-readable storage medium, storing computer-executable instructions, the computer-executable instructions, where the computer-executable instructions are configured to cause a computer to perform the data retrieval method based on cloud computing.

### BRIEF DESCRIPTION OF FIGURES

In order to more clearly illustrate the technical solutions in the embodiments of the present disclosure, the accompanying drawings to be used in the description of the embodiments will be briefly introduced below, and it is obvious that the accompanying drawings in the following description are only some embodiments of the present disclosure, and for the person of ordinary skill in the field, other accompanying drawings can be obtained based on these drawings without putting in creative labor.

FIG. 1 is an architectural schematic diagram of a data retrieval system based on cloud computing provided by embodiments of the present disclosure.

FIG. 2 is a flowchart of a data retrieval method based on cloud computing provided by embodiments of the present disclosure.

FIG. 3 is a structural schematic diagram of a retrieval engine provided by embodiments of the present disclosure.

FIG. 4 is a structural schematic diagram of a data retrieval apparatus based on cloud computing provided by embodiments of the present disclosure.

### DETAILED DESCRIPTION

In order to make the objects, technical solutions and advantages of the present disclosure clearer, the present disclosure will be described in further detail in the following in connection with the accompanying drawings, and it is obvious that the described embodiments are only a part of the embodiments of the present disclosure and not all of the embodiments. Based on the embodiments of the present disclosure, all other embodiments obtained by a person of ordinary skill in the art without creative labor fall within the claimed scope of the present disclosure.

FIG. 1 exemplarily illustrates a architectural schematic diagram of a data retrieval system based on cloud computing to which embodiments of the present disclosure apply, the system architecture including a scheduling service 110 and a retrieval engine 120.

The scheduling service 110 is configured for acquiring a retrieval request and sending the retrieval request to the retrieval engine 120. The retrieval request includes a first request field. For example, the scheduling service obtains the retrieval request sent by a user through an API (Application Programming Interface). The request field indicates a field to be retrieved, such as a height, weight, order number, and other fields. The request field may include a plurality of fields, such as including fields a, b, and c.

The retrieval engine 120 includes a plurality of retrieval engines; such as including a retrieval engine j1, a retrieval engine j2, a retrieval engine, . . . , a retrieval engine jn; where n represents a number of retrieval engines. The retrieval engine interfaces with the cloud database for retrieving data from the cloud database. Correspondingly, the cloud database and the retrieval engine are corresponding, such as the cloud database s1 is interfaced with the retrieval engine j1. However, the cloud database s1 may include multiple databases, which are not limited herein.

For any of the retrieval engines, a retrieval condition is set. Therefore after this retrieval engine obtains the first request field, this retrieval engine first determines whether the first request field satisfies the retrieval condition, and if it does not satisfy the retrieval condition, this retrieval engine generates, based on the first request field, a second request field that satisfies the retrieval condition. For example, the first request field includes three fields a, b, and c, the data in the cloud database with which the retrieval engine interfaces does not have the field c, and thus indicates that the field c does not satisfy the retrieval condition of the retrieval engine. A second request field that satisfies the retrieval condition will then be generated based on the first request field; and the second request field includes only two fields a and b.

After generating the second request field, the retrieval engine retrieves data from the cloud database based on the second request field to obtain a first retrieval result.

The retrieval engine is used to integrate the first retrieval results respectively retrieved by the retrieval engines after the retrieval engines retrieve the first retrieval results to obtain cache data. The cache data is used for secondary retrieval by the user.

It should be noted that the structure shown in FIG. 1 above is only an example, and the embodiments of the present disclosure are not limited thereto.

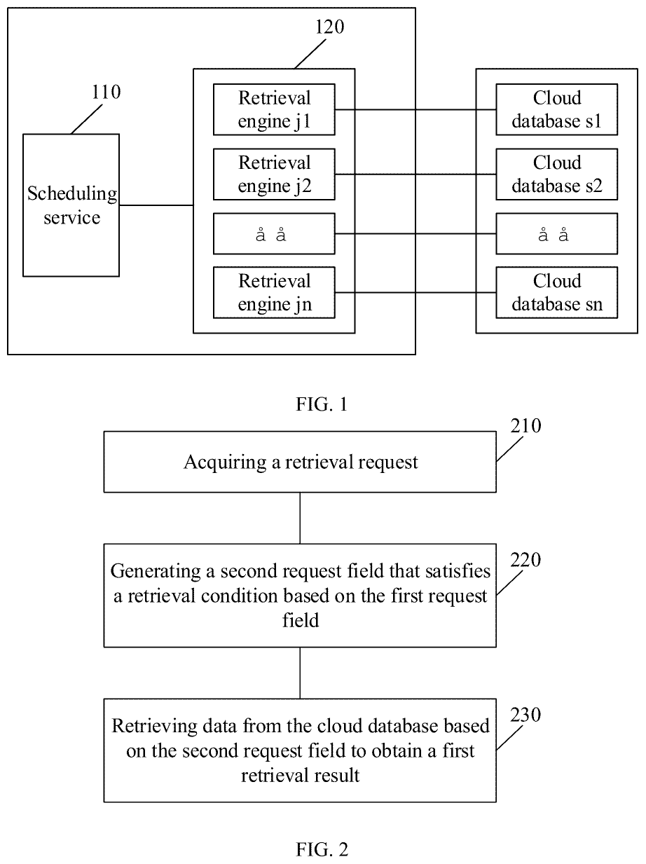

Based on the above description, FIG. 2 exemplarily illustrates a schematic diagram of a flowchart of a data retrieval method based on cloud computing provided by embodiments of the present disclosure, which may be executed by a data retrieval apparatus based on cloud computing.

As shown in FIG. 2, the flowchart includes the following.

At step 210, a retrieval request is acquired.

The retrieval request includes a first request field. The retrieval request is sent by the user, and the scheduling service receives the retrieval request and sends the retrieval request to each retrieval engine. For example, the user sends the retrieval request to the scheduling service via a UI (User Interface) or a CLI (command-line interface). The first request field of the retrieval request may include a plurality of fields, e.g., including four fields a, b, c, and d, which are a province area field, a city area field, a county area field, and a town area field, respectively. The retrieval request indicates retrieving a population number of town d, county c, city b, province a.

At step 220, based on the first request field, a second request field satisfying a retrieval condition is generated.

The first request field is different from the second request field; and the retrieval condition is generated based on a field of data in the cloud database and denotes a field in the cloud database that is allowed to index data. For example, the cloud database s1 stores data in the form of “key-value”, and the primary key “key” includes three fields a, b, and c. Then it means that the fields of the data allowed to be indexed in the cloud database s1 are a, b, c. In other words, the retrieval condition of the retrieval engine JI is that the request field is within the range of the three fields a, b, and c.

In some implementable ways, the retrieval conditions of the retrieval engines are different and the first request field does not satisfy the retrieval conditions of the retrieval engines. For example, the retrieval engine j1 interfaces with the cloud database s1; the data record of the cloud database s1 includes the population number of county c, city b, province a, excluding the population number of each town area under county c.

In other words, the retrieval condition of the retrieval engine j1 can only query the three fields a, b and c. Therefore, the retrieval engine j1, based on the first request field, generates the second request field that satisfies the retrieval condition of the retrieval engine according to the retrieval condition, that is, the second request field includes the three fields a, b, and c.

In some implementable ways, if the first request field satisfies the retrieval conditions of the retrieval engines, the first request field is directly used as the second request field.

At step 230, data is retrieved from the cloud database based on the second request field to obtain a first retrieval result.

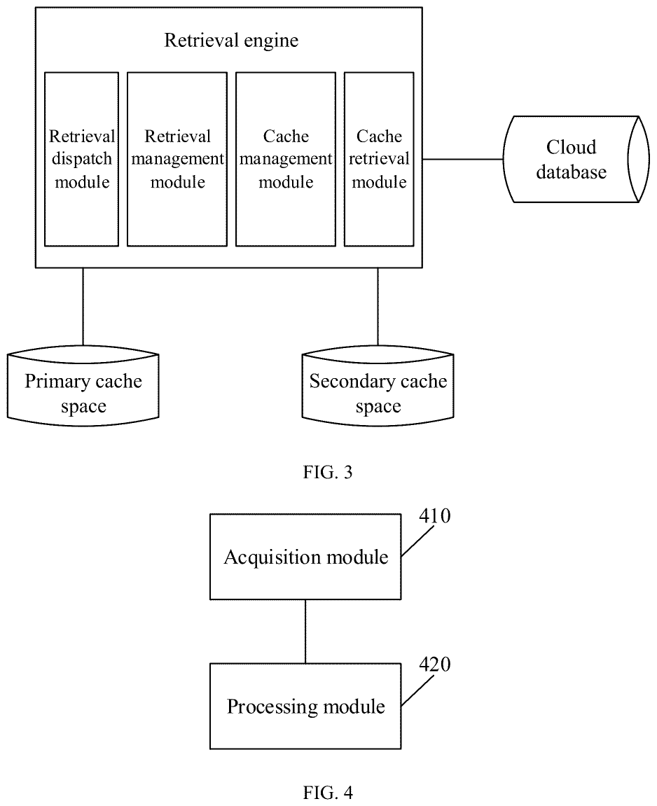

FIG. 3 is a structural schematic diagram of a retrieval engine exemplarily illustrated in the present disclosure. As shown in FIG. 3, the retrieval engine includes a retrieval dispatch module, a retrieval management module, a cache management module, and a cache retrieval module. The retrieval dispatch module is used to, according to the retrieval condition, generate a second request field satisfying the retrieval condition of the retrieval engine based on the first request field; the retrieval management module is used to retrieve data from the cloud database based on the second request field, and add the first retrieval result to the primary cache space; the cache retrieval module is used to retrieve data from the primary cache data based on the first request field and cache the second retrieval result to the secondary cache space; and the cache management module is used to feed back the secondary cache data, as well as to adjust the primary cache data and the secondary cache data in real time.

The retrieval engine caches the first retrieval results to the primary cache space to obtain the primary cache data. The primary cache space includes a first conditional sequence list; a mapping relationship between the first request field and a primary index is recorded in the first conditional sequence list; and the primary index is used to index the primary cache data.

The mapping relationship between the first request field and the primary index is shown in Table 1 below.

TABLE 1

| First Request Field | Primary Index |
|---|---|
| cond_1 | index_1 |
| cond_2 | index_2 |
| . . . | . . . |
| cond_m | index_m |

The mapping relationship between the primary index and the primary cache data is shown in Table 2 below.

TABLE 2

| Primary Index | Primary Cache Data |
|---|---|
| index_1 | data_1 |
| index_2 | data_2 |
| . . . | . . . |
| index_m | data_m |

The first request field is organized to form an ordered field sequence based on an element field. Core attributes of a condition element are an unique ID, a type, and supported operators of the element field. In the assembly process, after sorting element fields by value sizes of the unique IDs of the element fields, conditional fields are spliced. The mapping relationship between each field and the primary index is stored in the primary cache space.

In some implementable ways, the first request field includes a plurality of fields; the retrieval engine is further used to sort and group the plurality of fields; and the first retrieval results are sorted based on the sorting and grouping of the plurality of fields.

That is, the retrieval engine is further used to perform conditional cleaning on the first request field. The conditional cleaning refers to converting complex natural language retrieval fields of various forms into standard retrieval fields of the retrieval engine. For example, the natural language retrieval field is “slim body type”, which is converted into the standard retrieval fields of the retrieval engine as “weight, BMI index”, etc.

The cleaning process includes field encoding, field sorting, and field grouping. The condition encoding is realized by matching request field input by the user with the unique ID of the element field in the standard field, and each condition field will be matched to the unique element field.

Field sorting means sorting the element fields by in numerical order of IDs of the element fields from smallest to largest in accordance with the definition of the element fields.

Field grouping means that the standard retrieval fields are planned to be included in different memory groups according to the business domain in order to realize the grouping of the primary cache data.

In some embodiments, the retrieval engine is further used to query a capacity of the primary cache space and a capacity of the first retrieval result, and calculate the capacity for caching the primary cache data based on the capacity of the primary cache space and the capacity of the first retrieval result. The capacity for caching the primary cache data is directly proportional to the capacity of the primary cache space; and the capacity for caching the primary cache data is inversely proportional to the capacity of the first retrieval result.

By means of the above technical solution, the control of the cache expansion rate index is adaptively realized, and the management of the cache space is realized. In some embodiments, the primary cache data that is not used temporarily can be placed into a high-speed disk array used as a temporary exchange space, the details of which are not limited herein.

For example, the retrieval instructions are dispatched to the retrieval engine after amplifying the limitations on the result set in the retrieval condition combined with the remaining cache capacity by 5-10 times. The specific amplification ratio adopts the ratio of the remaining capacity to the total capacity, linear amplification, and the maximum is 10 times or other multiples, which is not limited herein.

After querying the primary cache data, the retrieval engine retrieves data from the primary cache data according to the first request field to obtain a second retrieval result, caches the second retrieval result to a secondary cache space to obtain secondary cache data. The secondary cache space includes a second conditional sequence list; the second conditional sequence list records a mapping relationship between the first request field and a secondary index; and the secondary index is used to index the secondary cache data, and finally feeds back the secondary cache data for the user to view.

The mapping relationship between the first request field and the secondary index is shown in Table 3 below.

TABLE 3

| First Request Field | Secondary Index |
|---|---|
| cond_1 | rsindex_1 |
| cond_2 | rsindex_2 |
| . . . | . . . |
| cond_m | rsindex_m |

The mapping relationship between the secondary index and the secondary cache data is shown in Table 4 below.

TABLE 4

| Secondary Index | Secondary Cache Data |
|---|---|
| rsindex_1 | r_data_1 |
| rsindex_2 | r_data_2 |
| . . . | . . . |
| rsindex_m | r_data_m |

In this case, the primary key and the primary cache data is a standard field sequence, and the difference with the primary cache is that its corresponding value is an index value of the first retrieval result. The index is used to query the real data in the first retrieval result.

In the embodiment of the present disclosure, the secondary cache data supports two types of retrieval, namely: regular hash retrieval and fuzzy matching, sorting, and grouping retrieval. For the regular hash retrieval, it is obtained by two calculations directly in the hash table. For retrieval containing fuzzy matching, sorting, and grouping, it is obtained after processing the primary cache data in accordance with the corresponding processing requirements by way of expanding the special retrieval implementation logic in the retrieval engine.

In some embodiments, the retrieval engine is further used to receive an elimination instruction for the primary cache data. The elimination instruction is sent after the primary cache data has been modified.

The retrieval engine deletes the secondary cache data corresponding to the elimination instruction from the secondary cache space.

That is to say, for the secondary cache data, the embodiments of the present disclosure provide a mechanism of two-way feedback; the two-way feedback means that the secondary cache data, on the one hand, receives the request of the primary cache data regarding the elimination of the cache data, and, on the other hand, feeds back its own hit rate situation to the primary cache data. This ensures the consistency of the primary cache data and the secondary cache data. The hit rate indicates a hit rate of the user viewing the secondary cache data.

Since there is a logical delay in the hit rate response of the primary cache data compared to that of the secondary cache data, when the secondary cache data does not hit the data, it actively detects the data availability of the primary cache to improve the accuracy of the query data. For example, a data parameter in the primary cache data changes from “1” to “2” because the secondary cache data is retrieved from the primary cache data, and assuming that the data is the secondary cache data, the secondary cache data is no longer consistent with the primary cache data. Therefore, in order to ensure data consistency, the secondary cache data will be forced to be invalidated.

In addition, the granularity of the invalidation processing of the secondary cache data can be set by the apparatus, which can differentiate among updates at the table level, the record level, the field level, and the field level, and eliminate the corresponding secondary cache data when an update occurs to the data that satisfies the condition.

In some embodiments, the primary cache data that has not been hit in a preset period is deleted from the primary cache space. That is, the primary cache space is released, thereby reducing the consumption of computing resources.

For example, if the user did not view a certain portion of the primary cache data in 3s (within the preset period), that portion of the primary cache data is deleted from the primary cache space.

In some implementable ways, the retrieval engine also queries homogeneous data in the first retrieval results of the plurality of retrieval engines based on a cloud-native traffic diversion records; and the homogeneous data in the first retrieval results of the plurality of retrieval engines is de-duplicated and then cached into the primary cache space.

The homogeneous data denotes identical data. The integrated architecture of cloud environment brings the homogeneous data problem, and most typically, the data of the disaster recovery system data is exactly the same as that of the main center data. In addition, different downstream application nodes (not source nodes) may store essentially the same data content. Traffic of the disaster recovery node is completely transferred to the main center node. Traffic of the downstream application node is completely transferred to the upstream application node (source node).

Therefore, the homogeneous data from the upstream application node and the downstream node can be queried through the traffic transfer records, and the homogeneous data from the downstream node can be deleted, thus realizing the effect of de-duplication.

Based on the same technical idea, FIG. 4 exemplarily illustrates a structural schematic diagram of a data retrieval apparatus based on cloud computing provided by embodiments of the present disclosure, which can perform the process of the data retrieval method based on cloud computing.

As shown in FIG. 4, the apparatus includes: an acquisition module 410, configured for acquiring a retrieval request; where the retrieval request includes a first request field; and a processing module 420, configured for generating a second request field that satisfies a retrieval condition based on the first request field, and retrieving data from a cloud database based on the second request field to obtain a first retrieval result; where the first request field is different from the second request field, and the retrieval condition is generated based on a field of data in the cloud database and indicates a field in the cloud database that is allowed to index data.

Optionally, the processing module 420 is further configured for after obtaining the first retrieval result, querying homogeneous data in the first retrieval result based on a cloud-native traffic transfer record; and after de-duplicating the homogeneous data in the first retrieval result, caching the de-duplicated first retrieval result to a primary cache space to obtain primary cache data; where the primary cache space includes a first conditional sequence list, a mapping relationship between the first request field and a primary index is recorded in the first conditional sequence list, and the primary index is used to index the primary cache data.

Optionally, the first request field includes a plurality of fields.

The processing module 420 is further configured for: calculating a capacity for caching the primary cache data; sorting and grouping fields in the first request field; sorting the de-duplicated first retrieval result based on the sorting and grouping of the fields; and caching the sorted first retrieval result to the primary cache space based on the capacity for caching the primary cache data.

Optionally, the processing module 420 is further configured for: querying a capacity of the primary cache space and a capacity of the first retrieval result; and calculating the capacity for caching the primary cache data based on the capacity of the primary cache space and the capacity of the first retrieval result; where the capacity for caching the primary cache data is directly proportional to the capacity of the primary cache space, and the capacity for caching the primary cache data is inversely proportional to the capacity of the first retrieval result.

Optionally, the processing module 420 is further configured for: retrieving data from the primary cache data according to the first request field to obtain a second retrieval result; caching the second retrieval result to a secondary cache space to obtain secondary cache data; where the secondary cache space includes a second conditional sequence list, a mapping relationship between the first request field and a secondary index is recorded in the second conditional sequence list, and the secondary index is used to index the secondary cache data; and feeding back the secondary cache data.

Optionally, the processing module 420 is further configured for: receiving an elimination instruction for primary cache data; where the elimination instruction is sent after the primary cache data has been modified; deleting from the secondary cache space the secondary cache data corresponding to the elimination instruction; and deleting from the primary cache space the primary cache data that has not been hit in a preset period.

Based on the same technical conception, embodiments of the present disclosure also provide a computer device including: a memory, configured for storing program instructions; a processor, configured for invoking the program instructions stored in the memory to execute the data retrieval method based on cloud computing in accordance with the obtained program.

Based on the same technical idea, embodiments of the present disclosure also provide a computer-readable storage medium, storing computer-executable instructions, where the computer-executable instructions are configured to cause the computer to execute the above-described data retrieval method based on cloud computing.

It should be appreciated by those skilled in the art that the embodiments of the present disclosure may be provided as methods, systems, or computer program product systems. Thus, the present disclosure may take the form of a fully hardware embodiment, a fully software embodiment, or an embodiment that combines software and hardware aspects. Further, the present disclosure may take the form of a computer program product system implemented on one or more computer-usable storage media (including, but not limited to, disk memory, CD-ROM, optical memory, and the like) that contain computer-usable program codes therein.

The present disclosure is described with reference to flowcharts and/or block diagrams of methods, devices (systems), and computer program product systems according to the present disclosure. It should be understood that each of the processes and/or blocks in the flowchart and/or block diagram, and the combination of processes and/or blocks in the flowchart and/or block diagram, may be implemented by computer program instructions. These computer program instructions may be provided to a processor of a general-purpose computer, a special-purpose computer, an embedded processor, or other programmable data-processing device to produce a machine such that the instructions executed by the processor of the computer or other programmable data-processing device produce an apparatus for carrying out the function specified in the one or more processes of the flowchart and/or one or more blocks of the block diagram.

These computer program instructions may also be stored in computer-readable memory capable of directing the computer or other programmable data processing device to operate in a particular manner such that the instructions stored in the computer-readable memory produce an article of manufacture including an instruction apparatus that implements the function specified in the one or more processes of the flowchart and/or one or more blocks of the block diagram.

These computer program instructions may also be loaded onto a computer or other programmable data processing device such that a series of operational steps are performed on the computer or other programmable device to produce computer-implemented processing, such that the instructions executed on the computer or other programmable device provide steps for implementing the function specified in the one or more processes of the flowchart and/or one or more blocks of the block diagram.

Obviously, those skilled in the art can make various changes and variations to the present disclosure without departing from the spirit and scope of the present disclosure. Thus, to the extent that such modifications and variations of the present disclosure are within the scope of the present claims and their technical equivalents, the present disclosure is intended to encompass such modifications and variations.

1. A data retrieval method based on cloud computing, comprising:
acquiring a retrieval request; wherein the retrieval request comprises a first request field;
generating a second request field that satisfies a retrieval condition based on the first request field; wherein the first request field is different from the second request field, and the retrieval condition is generated based on a field of data in a cloud database and indicates a field in the cloud database that is allowed to index data; and
retrieving data from the cloud database based on the second request field to obtain a first retrieval result.

2. The data retrieval method according to claim 1, further comprising: after obtaining the first retrieval result,
querying homogeneous data in the first retrieval result based on a cloud-native traffic transfer record; and
after de-duplicating the homogeneous data in the first retrieval result, caching the de-duplicated first retrieval result to a primary cache space to obtain primary cache data; wherein the primary cache space comprises a first conditional sequence list, a mapping relationship between the first request field and a primary index is recorded in the first conditional sequence list, and the primary index is used to index the primary cache data.

3. The data retrieval method according to claim 2, wherein the caching the de-duplicated first retrieval result to the primary cache space to obtain the primary cache data comprises:
calculating a capacity for caching the primary cache data;
sorting and grouping fields in the first request field;
sorting the de-duplicated first retrieval result based on the sorting and grouping of the fields; and
caching the sorted first retrieval result to the primary cache space based on the capacity for caching the primary cache data.

4. The data retrieval method according to claim 3, wherein the calculating the capacity for caching the primary cache data comprises:
querying a capacity of the primary cache space and a capacity of the first retrieval result; and
calculating the capacity for caching the primary cache data based on the capacity of the primary cache space and the capacity of the first retrieval result; wherein the capacity for caching the primary cache data is directly proportional to the capacity of the primary cache space, and the capacity for caching the primary cache data is inversely proportional to the capacity of the first retrieval result.

5. The data retrieval method according to claim 3, further comprising: after obtaining the primary cache data,
retrieving data from the primary cache data according to the first request field to obtain a second retrieval result;
caching the second retrieval result to a secondary cache space to obtain secondary cache data; wherein the secondary cache space comprises a second conditional sequence list, a mapping relationship between the first request field and a secondary index is recorded in the second conditional sequence list, and the secondary index is used to index the secondary cache data; and
feeding back the secondary cache data.

6. The data retrieval method according to further comprising:
receiving an elimination instruction for primary cache data; wherein the elimination instruction is sent after the primary cache data has been modified;
deleting from the secondary cache space the secondary cache data corresponding to the elimination instruction; and
deleting from the primary cache space the primary cache data that has not been hit in a preset period.

7. (canceled)

8. A data retrieval system based on cloud computing, comprising:
a scheduling service and a plurality of retrieval engines; wherein the plurality of retrieval engines are provided with different retrieval conditions; and for any retrieval engine, the retrieval condition of the retrieval engine is generated based on a field of data in a cloud database interfaced with the retrieval engine, and indicates a field in the cloud database that is allowed to index data;
the scheduling service is configured for acquiring a retrieval request and sending the retrieval request to the retrieval engine; wherein the retrieval request comprises a first request field;
for any retrieval engine, the retrieval engine is configured for generating a second request field that satisfies a retrieval condition of the retrieval engine based on the first request field; wherein the first request field is different from the second request field; and
the retrieval engine retrieves data from the cloud database based on the second request field to obtain a first retrieval result.

9. A computer device, comprising:
a memory, configured for storing program instructions;
a processor, configured for invoking the program instructions stored in the memory to execute the data retrieval method according to claim 1 in accordance with obtained program.

10. (canceled)

11. The computer device according to claim 9, wherein the processor is further configured for: after obtaining the first retrieval result,
querying homogeneous data in the first retrieval result based on a cloud-native traffic transfer record; and
after de-duplicating the homogeneous data in the first retrieval result, caching the de-duplicated first retrieval result to a primary cache space to obtain primary cache data; wherein the primary cache space comprises a first conditional sequence list, a mapping relationship between the first request field and a primary index is recorded in the first conditional sequence list, and the primary index is used to index the primary cache data.

12. The computer device according to claim 9, wherein the processor is further configured for:
calculating a capacity for caching the primary cache data;
sorting and grouping fields in the first request field;
sorting the de-duplicated first retrieval result based on the sorting and grouping of the fields; and
caching the sorted first retrieval result to the primary cache space based on the capacity for caching the primary cache data.

13. The computer device according to claim 12, wherein the processor is further configured for:
querying a capacity of the primary cache space and a capacity of the first retrieval result; and
calculating the capacity for caching the primary cache data based on the capacity of the primary cache space and the capacity of the first retrieval result; wherein the capacity for caching the primary cache data is directly proportional to the capacity of the primary cache space, and the capacity for caching the primary cache data is inversely proportional to the capacity of the first retrieval result.

14. The computer device according to claim 12, wherein the processor is further configured for: after obtaining the primary cache data,
retrieving data from the primary cache data according to the first request field to obtain a second retrieval result;
caching the second retrieval result to a secondary cache space to obtain secondary cache data; wherein the secondary cache space comprises a second conditional sequence list, a mapping relationship between the first request field and a secondary index is recorded in the second conditional sequence list, and the secondary index is used to index the secondary cache data; and
feeding back the secondary cache data.

15. The computer device according to claim 9, wherein the processor is further configured for:
receiving an elimination instruction for primary cache data; wherein the elimination instruction is sent after the primary cache data has been modified;
deleting from the secondary cache space the secondary cache data corresponding to the elimination instruction; and
deleting from the primary cache space the primary cache data that has not been hit in a preset period.
